(19) United States
(12) Patent Application Publication
(10) Pub. No.: US 2016/0343530 A1
(43) Pub. Date: Nov. 24, 2016

(54) SWITCHING SYSTEM AND CIRCUIT BREAKER

(71) Applicant: ELLENBERGER & POENSGEN GMBH, Altdorf (DE)

(72) Inventors: THORSTEN SCHRANK, BERLIN (DE); MICHAEL KURRAT, BRAUNSCHWEIG (DE); ERNST-DIETER WILKENING, BRAUNSCHWEIG (DE)

(21) Appl. No.: 15/230,628

(22) Filed: Aug. 8, 2016

Related U.S. Application Data
(63) Continuation of application No. PCT/EP2015/000061, filed on Jan. 15, 2015.

(30) Foreign Application Priority Data
Feb. 8, 2014 (DE) 102014001730.3

(51) Int. Cl. H01H 73/18; H01H 9/30; H01H 9/44; H01H 9/34

(52) U.S. Cl. CPC H01H 73/18; H01H 9/342; H01H 9/302; H01H 9/443

(57) ABSTRACT

A switching system has a first contact and a second contact which can be moved in relation to each other in an opening direction. The switching system contains a quenching chamber and a drive element for driving an arc into the quenching chamber. The quenching chamber contains a quenching element made of a porous material.

### CROSS-REFERENCE TO RELATED APPLICATION

This is a continuation application, under 35 U.S.C. §120, of copending international application No. PCT/EP2015/000061, filed Jan. 15, 2015, which designated the United States; this application also claims the priority, under 35 U.S.C. §119, of German patent application No. 10 2014 001 730.3, filed Feb. 8, 2014; the prior applications are herewith incorporated by reference in their entirety.

### BACKGROUND OF THE INVENTION

### Field of the Invention

The invention relates to a switching system with a first contact and a second contact which are moveable in relation to each other in an opening direction. The switching system is specifically configured for low-voltage duty, preferably for a relay or a contactor, wherein the switchable voltages are up to 1500V in DC voltage duty, and up to 1000V in AC voltage duty.

A circuit-breaker for DC and AC with two contact points is known from German patent DE 10 2009 013 337 B4. A contact bridge is arranged between the contact points which, upon the tripping of the circuit-breaker, is moved in a transverse direction. The arcs generated on the two contact points are driven by a blowout arrangement. One of the two arcs is thus driven to an edge zone of the contact bridge, whereas one of the roots of the other arc, by baffles, is essentially brought into electrical contact with the two contact points. In other words, by means of the second arc, the two contact points are electrically short-circuited, and the second arc assumes the electrical function of the contact bridge in the closed state. The second arc is thus connected in parallel with the contact bridge. The first of the two arcs is thus quenched. The remaining arc is driven by a further blowout arrangement into a quenching chamber, where it is quenched.

### SUMMARY OF THE INVENTION

The object of the invention is the proposal of a particularly appropriate switching system with a first contact and a second contact, which are moveable in relation to each other in an opening direction, and a circuit-breaker containing the switching system, wherein an arc generated between the two contacts is relatively efficiently quenched, and wherein the weight and size are specifically reduced.

The switching system has a first contact and a second contact, which are electrically connected in series and conduct current within the switching system. The two contacts are moveable in relation to each other in an opening direction. For example, the first contact is fixed, and is thus maintained in a stationary position by other elements of the switching system. The second contact is arranged to move, for example by means of a hinge, for example a film hinge or similar. In other words, the first contact is a fixed contact and the second contact is a moveable contact. Alternatively, both contacts are arranged to move within the switching system. Specifically, the first contact is arranged for movement by means of a hinge. Alternatively, or in combination, at least one of the contacts is arranged for movement in a transverse direction.

With the switching system in the conducting state, the two contacts are preferably in direct mechanical contact and, in the non-conducting state, are mutually spaced. To this end, the contacts are mutually moved in the opening direction. The opening direction is specifically understood as the direction in which the second contact is moved relatively to the first contact in order to switch the system from the conducting to the non-conducting state. For example, the second contact is moved transversely to the first contact. The opening direction is thus the direction which runs parallel to a transverse straight line. Alternatively, the second contact rotates in relation to the first contact, specifically by means of a hinge or a stationary axis. In this case, the opening direction is tangential to the axis of rotation.

The switching system contains a quenching chamber with a quenching element, wherein the quenching chamber is specifically arranged adjacently to the two contacts. The quenching element of the quenching chamber is formed of a porous material. Specifically, the quenching chamber is essentially comprised of the quenching element, or is only provided additionally with a carrier for the quenching element. An open-pored porous material is specifically preferred. In other words, the individual pores in the material are interconnected. Appropriately, the quenching element is not electrically conductive, and is thus formed of an electrically insulating material.

The switching system also contains a drive element for driving an arc into the quenching chamber. The quenching chamber, the drive element and the two contacts are arranged such that, upon the opening of the two contacts, the arc generated between the latter is driven by the drive element into the quenching chamber. Upon a switchover of the switching system from a conducting to a non-conducting state, it is possible that, as a result of a comparatively high electric voltage, a plasma is formed between the first contact and the second contact, thereby resulting in the generation of an arc, through which an electric current flows. Consequently, a current flow is maintained in the switching system, even when the contacts are open. By means of the drive element, the arc is driven into the quenching chamber, and is propagated in the quenching element. Specifically, a plasma forms in the area of the pores, through which the current flows. In other words, the length of the arc formed between the two contacts is increased, as the arc is only propagated within the pores. Moreover, by the appropriate selection of pore size, the cross-section of the arc can be limited. Consequently, the electric voltage which is required to sustain the arc is increased.

A thermal exchange occurs between the plasma and the comparatively cool quenching element. As a result of the large contact surface between the plasma and the quenching element, the thermal exchange is comparatively efficient, thereby resulting in the comparatively strong cooling of the plasma. The cooling of the plasma, and the associated removal of energy, increases the electrical field strength of the arc. Between the first and the second contact, this results in a strong and rapid rise in the arc voltage. Immediately the arc voltage achieves the value of the electric voltage on the switching system, or exceeds the latter, this results in the limitation and the reduction of the current flow, which is ultimately interrupted. To summarize, the arc is cooled in a comparatively efficient manner and is limited in its cross-section, and is quenched relatively rapidly as a result, thereby setting the switching system to a non-conducting state.

By the use of a porous material, it is possible to produce a comparatively lightweight and compact switching system. Moreover, the production of a porous material is simpler and more rapid than, for example, the arrangement of arc splitters. Consequently, the switching system can be produced comparatively rapidly and cost-effectively. Moreover, the rising ramp rate of the arc field strength is comparatively high, thereby permitting the comparatively rapid switchover of the switching system to a non-conducting state.

The switching system is appropriately employed in a motor vehicle or an aircraft, which is made possible by the comparatively lightweight and compact design of the switching system. The switching system is specifically configured for high DC voltages, preferably for high-voltage relays or for a contactor. The switching system, preferably in combination with a switch in the form of a relay or a contactor, is suitable for high DC voltages e.g. of at least 330V, and for the accommodation and interruption of a permanent current e.g. of at least 32 A, 100 A, 320 A or 1000 A. Specifically, the switching system is suitable for the accommodation and interruption of a permanent current of up to several hundred amperes and a permanent voltage of several hundred volts, wherein the switchable voltages e.g. are up to 1500V in DC voltage duty and up to 1000V in AC voltage duty.

The porous material preferably has a pore density, also described as a cell width, of between 20 ppi and 30 ppi (pores per inch). In other words, the number of pores per inch ranges from 20 to 30. In other words again, the number of pores ranges from 7.5 to 12 per centimeter. Appropriately, the density is equal to 20 ppi, 25 ppi or 30 ppi. By means of a cell width of this type, a comparatively strong fragmentation of the arc within the quenching element is achievable. Consequently, an arc is quenched relatively rapidly within the quenching element.

Appropriately, the porous material has a porosity of between 70% and 90%, wherein the porosity represents the ratio of the volume of voids to the total volume. The ratio of the total volume minus the volume of voids to the total volume, described as the solid content of the porous material, is specifically equal to 10%, 20% or 30%. The selection of a corresponding porosity value firstly ensures the comparatively high structural stability of the quenching element. Secondly, a comparatively high number of voids is provided, within which the arc can be propagated.

In a specifically preferred form of embodiment, the porous material is a ceramic foam, which is specifically open-pored. A comparatively stable quenching element is provided accordingly. In a specifically preferred form of embodiment of the invention, the porous material is Al₂O₃. By the selection of a material of this type, the quenching element is comparatively resistant to high temperatures associated with the presence of an arc. Consequently, a comparatively high number of switching operations can be executed by the switching system, wherein the contact erosion sustained by the quenching element is relatively minor. Moreover, the formation of an electrical short-circuit by the quenching element is precluded by the comparatively high specific electrical resistance of the material.

The quenching element is configured, for example, as a hollow cylinder. Specifically, the cross-section of the quenching element, perpendicularly to the cylindrical axis thereof, is annular. The second contact is at least partially arranged within the quenching element. For example, the second contact is guided by the central recess in the quenching element. By this arrangement, the quenching chamber surrounds the second contact, and an arc which is propagated between the second contact and the first contact is driven, comparatively rapidly, into the quenching chamber. Specifically, the first contact shows an essentially annular or disk-shaped configuration, and is in direct mechanical contact with one of the end surfaces of the hollow cylindrical quenching element. In the conducting state, the second contact is appropriately arranged within the quenching element, such that the second contact is in direct mechanical contact with the first contact. For the switchover of the system to a non-conducting state, the second contact is moved away from the first contact by the quenching element in the direction of opening, which is parallel to the cylindrical axis of the quenching element. By this arrangement, the arc is propagated within a specific zone, and any thermal loading or other damage to any other components of the switching system, or to any other elements, is precluded accordingly.

In an alternative form of embodiment of the invention, the switching system is provided with a third contact, the position of which is fixed in relation to the first contact. In other words, both the first and the third contacts are fixed contacts. Consequently, the second contact is moveable in relation to both the first and the third contacts. With the switching system in the conducting state, the third contact is specifically connected in series between the first and second contact. The quenching element is arranged between the first contact and the third contact. The second contact is appropriately configured such that the arc, prior to the quenching thereof, is propagated between the first and third contacts, and from thence is driven into the quenching element by the drive element. In other words, the arc, if it has not already been quenched en route to the quenching chamber, is driven into the quenching chamber. Specifically, the quenching element is in direct mechanical contact with both the first and the third contacts. By this arrangement, with effect from a specific time point, the propagation of the arc outside the quenching element is no longer possible. As a result of the direct mechanical contact, any propagation around the quenching element is not possible. Appropriately, the quenching element is essentially rectangular in shape. A design of this type facilitates the comparatively straightforward manufacture of the switching system.

Moreover, by the quenching element, a specific clearance is maintained between the first contact and the third contact such that, even in the event of any loosening of the attachment of the first and/or third contacts, the latter will not enter into direct mechanical contact, thereby short-circuiting the switching system.

For example, with the switching system in the conducting state, the second contact cooperates with the first contact and with the third contact. Appropriately, the second contact is essentially of rectangular design. With the switching system in the non-conducting state, the clearance between the second contact and the quenching element is enlarged appropriately. In other words, for the switchover of the switching system from the conducting state to the non-conducting state, the second contact is moved away from the quenching element. To this end, the two free ends of the second contact are appropriately arranged at a distance from both the first and the third contacts. Consequently, an arc is generated, firstly between the first and the second contacts, and between the second and third contacts. By use of the drive element, at least one of arcs is driven along the second contact, until the flashover thereof onto the first or the third contact occurs. In consequence, any further arcs generated between the second contact and the first or third contacts are extinguished. In other words, the second contact is no longer current-carrying, and an arc is only generated between the first and third contacts. From thence, the arc is driven by the drive element into the quenching chamber which is arranged between the two contacts, where it is quenched. In the configuration of a switching system of this type, the opening direction runs away from the quenching element and, specifically, is perpendicular to the shortest connecting distance between the first and third contacts.

Appropriately, the drive element is a magnetic element. In other words, a magnetic field is generated by the drive element. Alternatively, the drive element is provided with a plurality of magnetic elements, thereby resulting in a comparatively homogeneous magnetic field. Specifically, the drive element is a permanent magnet, which is preferably formed of a ferrite. By this arrangement, it is possible for the switching system to be manufactured comparatively cost-effectively. Alternatively, the permanent magnet is formed of NdFeB, which permits the production of a switching system with comparatively compact dimensions. In a further form of embodiment, the magnetic element is a coil, or is provided with at least one coil, generates a magnetic field when an appropriate current is passed through it.

Appropriately, the magnetic drive element is arranged adjacently to the quenching chamber and, preferably, the quenching chamber accommodates a comparatively high proportion of the flux associated with the magnetic field. Specifically, the magnetic field within the quenching chamber is equivalent to at least one quarter of the maximum magnetic field strength of the magnetic drive element. Appropriately, the magnetic field in the vicinity of the first and second contacts is perpendicular to the opening direction. By this arrangement, an arc which is generated between the first and second contacts, by the action of the Lorentz force, is moved away from its original position comparatively rapidly, and any contact erosion of the first and/or second contacts in the vicinity of a mutual mechanical installation is prevented.

Alternatively, the drive element is configured, for example, as a combustion element in the form of a solid body or a gel-type fluid, the boiling point of which lies below the temperature of the arc. Appropriately, the material of the combustion element is non-electrically-conductive, and is therefore an electrical insulator, e.g. Plexiglas. Specifically, the drive element is arranged in the area of the two contacts in which the arc is generated. Specifically, the point of the origin of the arc lies between the drive element and the quenching chamber. As a result of the propagation of the arc, the combustion element is at least partially converted into a gaseous state. The resulting gas stream from the gasified combustion element drives the arc into the quenching chamber.

The circuit-breaker preferably contains a switching system with a first contact and a second contact which are moveable in relation to each other in an opening direction. The switching system also contains a quenching chamber and a drive element for driving an arc into the quenching chamber, for example a magnetic element which generates a magnetic field, specifically a permanent magnet or an electromagnet. The quenching chamber is provided with a quenching element of a porous material. By the use of a porous material for the quenching element, it is possible for the circuit-breaker to assume a comparatively small, compact and lightweight construction. Specifically, the circuit-breaker is a constituent element of a photovoltaic installation or a motor vehicle. Specifically, the circuit-breaker is designed for the switching of comparatively high voltages, specifically equal to or greater than 450V, and/or high currents, specifically equal to or greater than 10 A. Specifically, the rated voltage of the circuit-breaker is 330V and the rated current is 32 A, 100 A or 320 A. For example, the rated current is 1000 A. Appropriately, the circuit-breaker is suitable for the accommodation and interruption of a permanent current of up to several hundred amperes and a permanent voltage of several hundred volts, wherein the switchable voltages e.g. are up to 1500V in DC voltage duty and up to 1000V in AC voltage duty. Additionally to the switching system, the circuit-breaker contains a monitoring device, by which the electric current flowing in the circuit-breaker and/or the electric voltage are monitored. The monitoring device is provided, for example, with electrical and/or electronic components, or contains a bimetallic element, which bends in the event of an overshoot of the rated voltage and/or the rated current.

Other features which are considered as characteristic for the invention are set forth in the appended claims.

Although the invention is illustrated and described herein as embodied in a switching system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, exploded perspective view of a first form of embodiment of a circuit-breaker with a switching system according to the invention; and

FIG. 2 is a cross-sectional view of a second form of embodiment of the circuit-breaker.

### DETAILED DESCRIPTION OF THE INVENTION

In all the figures, mutually corresponding elements are identified by the same reference numbers.

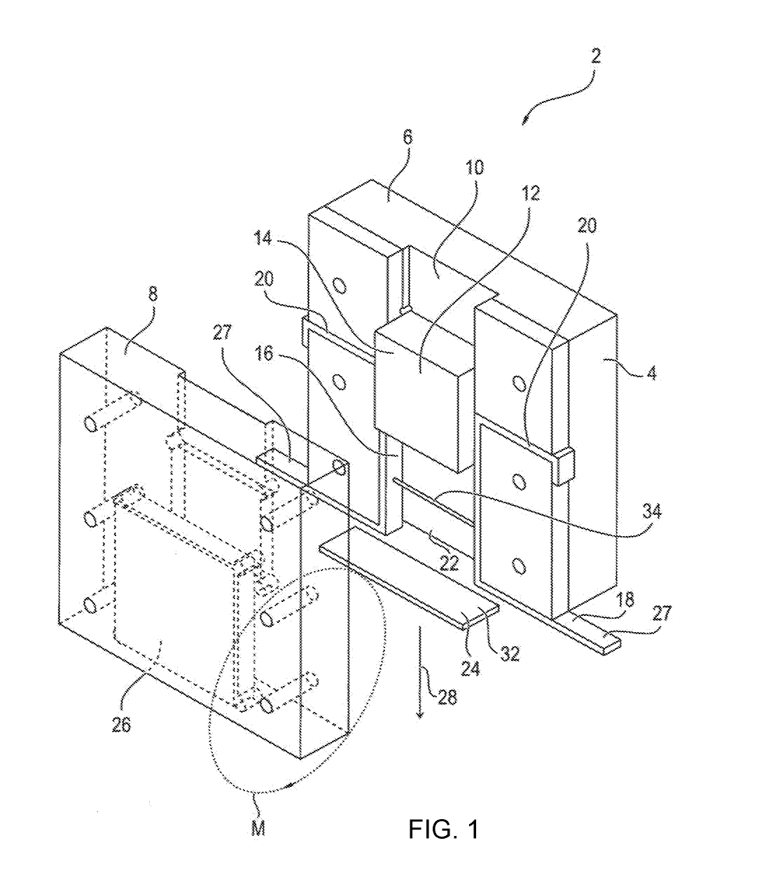

Referring now to the figures of the drawings in detail and first, particularly to FIG. 1 thereof, there is shown a simplified schematic sectional exploded view of a circuit-breaker 2. The axially-symmetrical circuit-breaker 2 contains a switching system 4 with a first housing section 6 and a second housing section 8. The first housing section 6 is provided with a groove 10, within which a quenching chamber 12 of rectangular design is arranged, formed of a quenching element 14 comprised of a porous material. The quenching element 14 is manufactured of Al₂O₃, and the porosity of the material used for the quenching element 14 is equal to 85%, with a pore density of 20 ppi. The lateral limiting surface of the groove 10 is partially formed by a first contact 16 and a third contact 18, which are formed respectively by copper strips bent into a U-shape. The copper strips engage respectively with one of the two mutually parallel flanks of a recess 20 in the first housing section 6. The flank connecting the two mutually parallel flanks forms the limiting surface of the groove 10. The quenching element 14 is in direct mechanical contact with the two flanks of the copper strips which form the limiting surface of the groove 10. The quenching element 14 is essentially arranged in the area of the two recesses 20, such that the groove 10 is subdivided by the quenching element.

The first contact 16, the third contact 18 and the quenching element 14 form an arcing chamber 22, which extends to the end of the groove 10. Here, in the conducting state, a second contact 24, in the form of a copper strip, is arranged. The second housing section 8 is provided with a permanent magnet 26, which covers the arcing chamber 22 and the magnetic field M of which is essentially perpendicular to the second contact 24 and the groove 10. In a variant, which is not represented here, the first housing section 6 is also provided with a permanent magnet, which is arranged in mirror-image to the permanent magnet 26 on the second housing section 8. By this arrangement, the magnetic field M in the area of the groove 10 is comparatively homogeneous.

The two flanks of the first contact 16 and the third contact 18, with which the second contact 14 cooperates in the conducting state, are provided with a terminal 27 on the free end side. In service, an electric current flows from the terminal 27 of the first contact 16 to the second contact 24, and via the latter to the third contact 18. Further components of a circuit, which are protected by the circuit-breaker 2, are connected to the terminal 27 of the third contact. For the switchover of the switching system to the non-conducting state, the second contact 24 is moved in an opening direction 28, which is parallel to the groove 10. The opening direction 28 is thus oriented away from the quenching element 14. The movement of the second contact 24 is effected by a guide system and mechanism, which are not represented here, actuated by a monitoring device, which is likewise not represented. By means of the latter, the current flowing between the two terminals 27 is detected and evaluated. If the current exceeds a specific rated value of 320 A, the second contact 24 is moved in the opening direction 28.

Between the free ends 32 of the second contact 24 and the respective adjoining first contact 16 or third contact 18, an arc is generated which, notwithstanding the open contacts 16, 18, 24, results in a continuing flow of current between the two terminals 27. By the action of the magnetic field M generated by the permanent magnet 26, which is perpendicular to the opening direction 28, these two arcs are moved. One end of one of the arcs is thus driven from one of the free ends 32 to the other free end 32 of the second contact 24, from whence this end of the arc sparks over to the first or third contacts 16, 18. Consequently, an arc 34 is generated between the first contact 16 and the third contact 18 within the arcing chamber 22, and the other arc is quenched. Accordingly, a current flows from the first contact 16 via the arc 34 to the third contact 18, and the circuit-breaker is current-carrying once more.

By the action of the Lorentz force, the arc 34 is driven against the opening direction 28 into the quenching chamber 12 by the permanent magnet 26. Immediately the arc 34 reaches the end of the arcing chamber 22, the arc 34 enters the quenching element 14. Here, the arc 34 is driven into the pores of the quenching element 14, thereby resulting in a restriction of the cross-section of the arc 34 and an increase in its length. As a result of the comparatively large contact surface between the arc 34 and the quenching element 14, a comparatively efficient cooling of the arc 34 is achieved. The arc voltage shows a comparatively strong increase, thereby resulting in the inhibition of the current flow between the two terminals 27.

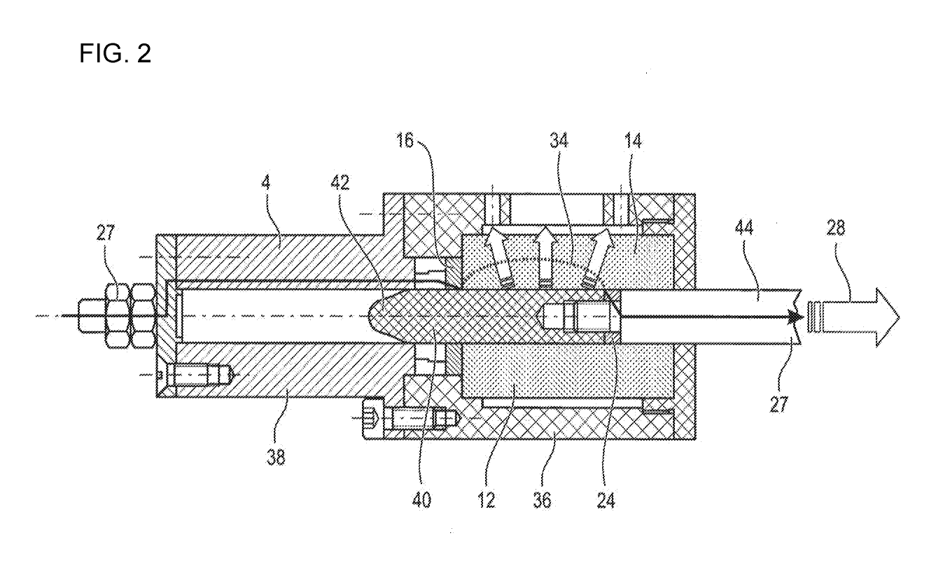

FIG. 2 shows a cross-sectional view along the opening direction 28 of a further form of embodiment of the switching system 4. The quenching element 14, which is formed of Al₂O₃, is a ceramic foam, and has a pore density of 30 ppi and a porosity of 80%. Moreover, the quenching element 14 is configured as a hollow cylinder and is arranged within a first housing 36. At one axial end of the quenching element 14 which extends in the opening direction 28, the annular first contact 16 is connected to the quenching element 14. The first contact 16 is also arranged for the closure of a cup-shaped second housing 38, at the base of which one of the terminals 27 is arranged. The opening of the cup-shaped second housing 38 is aligned with the first contact 16, which is arranged concentrically thereto, and with the central recess in the quenching element 14.

The second contact 24, which also has an annular configuration, is mounted on a pin 40 with a pin tip 42 of a non-conductive material, specifically Plexiglas or similar, and a pin shaft 44 of an electrically-conductive material. The second contact 24 is located between the pin tip 42 and the pin shaft 44, at the opposite end to the pin tip 42 of which the second terminal 27 of the switching system 4 is located. The pin 40 is arranged within the first housing 36 and the second housing 38, is form-fitted to the respective central recesses, and is guided by the latter.

With the switching system 4 in the conducting state, the pin 40 is located within the first housing 36 and the second housing 38. The pin tip 42 is thus inserted into the second housing 38 to the extent that the second contact 24 lies flush to the first contact 16. In other words, the pin tip 42 is essentially entirely located within the second housing 38. The second contact 24 is in direct mechanical contact with the first contact 16. Consequently, a current flows from the terminal 27 arranged on the second housing 38 via the second housing 38 and the first contact 16 to the second contact 24, and from thence via the pin shaft 44 to the terminal 27 which is fitted thereto.

For the interruption of the current flow, the pin 40 is moved outwards from the second housing 38 in the opening direction 28. The second contact 24 is thus moved by the quenching element 14 to the end of the first housing 36 facing away from the second housing 38. Consequently, an arc 34 is generated between the first contact 16 and the second contact 24 along the pin tip 42. As a result of the action of heat on the pin tip 42, the latter is partially vaporized, and the resulting increase in pressure generates a gas stream which runs perpendicularly to the opening direction 28. The particle stream drives the arc 34 radially outwards into the quenching element 14. As the pin 40 is progressively consumed, the length of the arc 34 increases. Consequently, the number of pores in the porous material of the quenching element 14 within which a plasma is generated or into which the plasma is driven increases, wherein the plasma carries the electric current flow between the two terminals 27. With effect from a specific clearance between the first contact 16 and the second contact 24, the strength of the reciprocal action between the arc 34 and the quenching element 14, and consequently the increase in the arcing voltage, is such that the current flow between the two terminals 27 is limited, and is ultimately inhibited.

The invention is not limited to the exemplary embodiments described above. Further variants of the invention can be inferred by a person skilled in the art, without departing from the object of the invention. Specifically, all the individual characteristics described with reference to the exemplary embodiments can be mutually combined in another manner, without departing from the object of the invention.

The following is a summary list of reference numerals and the corresponding structure used in the above description of the invention:
2 Circuit-breaker
4 Switching system
6 First housing section
8 Second housing section
10 Groove
12 Quenching chamber
14 Quenching element
16 First contact
18 Third contact
20 Recess
22 Arcing chamber
24 Second contact
26 Permanent magnet
27 Terminal
28 Opening direction
32 Free end
34 Arc
36 First housing
38 Second housing
40 Pin
42 Pin tip
44 Pin shaft
M Magnetic field

1. A switching system, comprising
a first contact;
a second contact moveable in relation to said first contact in an opening direction;
a quenching chamber having a quenching element formed of a porous material; and
a drive element for driving an arc into said quenching chamber.

2. The switching system according to claim 1, wherein said porous material has a pore density of between 20 ppi and 30 ppi.

3. The switching system according to claim 1, wherein said porous material has a porosity of between 70% and 90%.

4. The switching system according to claim 1, wherein said porous material is a ceramic foam.

5. The switching system according to claim 1, wherein:
said quenching element is configured as a hollow cylinder; and
said second contact is at least partially disposed within said quenching element.

6. The switching system according to claim 1,
further comprising a third contact, a position of said third contact is fixed in relation to said first contact; and
wherein said quenching element is disposed between said first and third contacts.

7. The switching system according to claim 6, wherein in a conducting state, said second contact cooperates respectively on a free end side with said first and third contacts and, in a non-conducting state, a clearance between said second contact and said quenching element is specifically increased.

8. The switching system according to claim 1, wherein said drive element is magnetic.

9. The switching system according to claim 8, wherein a magnetic field of said drive element in a vicinity of said first and second contacts is perpendicular to the opening direction.

10. The switching system according to claim 1, wherein said porous material is formed from Al₂O₃.

11. The switching system according to claim 6, wherein said quenching element is in direct mechanical contact with said third contact.

12. A circuit-breaker, comprising:
a switching system containing a first contact, a second contact moveable in relation to said first contact in an opening direction, a quenching chamber having a quenching element formed of a porous material, and a drive element for driving an arc into said quenching chamber.
